(19) United States
(12) Patent Application Publication
(10) Pub. No.: US 2006/0239810 A1
(43) Pub. Date: Oct. 26, 2006

(54) Apparatus for attaching a handheld tool to the bucket of a prime mover

(75) Inventors: G. Gregory Penza, Huntington, NY (US); George Lohr, Commack, NY (US); Hermann Herrlich, Lindenhurst, NY (US); Robert Chomicki, Hicksville, NY (US); Anthony DeStefano, Carlo Place, NY (US)

Correspondence Address: BROOKS KUSHMAN P.C., 1000 TOWN CENTER, TWENTY-SECOND FLOOR, SOUTHFIELD, MI, 48075, US

(73) Assignees: ULC Robotics, Inc., Deer Park, NY (US); Keyspan Corporation, Hicksville, NY (US)

(21) Appl. No.: 11/114,521

(22) Filed: Apr. 26, 2005

(51) Int. Cl. B66C 23/00

(52) U.S. Cl. 414/723

(57) ABSTRACT

An apparatus for attaching a handheld tool to a bucket of a prime mover includes a first plate having an aperture therethrough. The aperture is configured to receive a fastener for attaching the first plate to the bucket. A second plate is disposed opposite the first plate, and includes a second aperture therethrough for receiving a fastener for attaching the second plate to the bucket. A support structure is attached to the first and second plates, and is configured to support the handheld tool. A first clamp is attached to the support structure, and sized to receive a portion of the handheld tool, thereby at least partially securing the handheld tool to the support structure.

### BACKGROUND OF THE INVENTION

1. Field of the Invention

The present invention relates to an apparatus for attaching a handheld tool to the bucket of a prime mover.

2. Background Art

Construction equipment, such as backhoes and the like—referred to generically as prime movers—are used to perform a variety of tasks using various implements such as buckets, scrapers, etc. A device such as a backhoe, generally has an articulating boom to which one or more implements may be attached. One example of the use of a prime mover using various implements to perform different tasks is described in U.S. Patent Application Publication No. 2003/0131682, published on Jul. 17, 2003 (Crane et al.). Crane et al. describes a connector assembly for mounting an implement to the boom of a prime mover. For example, the connector assembly described in Crane et al. allows an implement, such as a hydraulic hammer, to be connected to the articulating boom of a backhoe.

One limitation of the connector assembly described in Crane et al., is that it attaches directly to the boom, rather than an existing implement. For example, if a bucket is attached to the boom of the backhoe, it must be removed prior to attaching a new implement, such as a hydraulic hammer. It would therefore be desirable to have an apparatus that facilitated attachment of different tools to the bucket of a backhoe, such that the different tools could be attached and removed from the prime mover, without the need to remove and reattach the bucket.

One attempt to address this issue is described in U.S. Pat. No. 3,864,793 issued to Guest on Feb. 11, 1975. Guest describes a tool attachment that includes a C-shaped bracket that attaches directly to a bucket on a piece of equipment, such as a backhoe. The C-shaped bracket is attached to the bucket via a clamp which is secured by turning a handle attached to a threaded rod. Although some tools may be specially configured for attachment directly to the C-shaped clamp, other tools, such as a pneumatic hammer, may require its own adapter, specially configured to be attached to the C-shaped clamp. Thus, the tools that can be used with the tool attachment described in Guest must be specially configured for use with the C-shaped clamp. Therefore, it would be desirable to have an apparatus for attaching a tool to the bucket of a prime mover, where the tool requires no special configuration to facilitate the attachment.

Another issue not addressed by conventional tool adapters used with prime movers is the need to facilitate attachment of a generally handheld tool to the prime mover. Conventional tool adapters are used with specially configured tools, which are usually designed for very large jobs. This is why they are configured for attachment to a large machine, such as a prime mover. In some cases, however, it may be desirable to attach a handheld tool to a prime mover, rather than having an operator hold the tool during use. This would allow the tool to be used a handheld tool on smaller jobs, while allowing it to be used in conjunction with the prime mover for larger jobs. Therefore, it would be desirable to have an apparatus for attaching a handheld tool to the bucket of a prime mover to maximize flexibility in the use of the tool.

### SUMMARY OF THE INVENTION

The present invention provides an apparatus for attaching a handheld tool to the bucket of a prime mover. The adapter includes a first plate, including a first aperture therethrough for receiving a fastener for attaching the first plate to the bucket. A second plate is disposed opposite the first plate and includes a second aperture therethrough for receiving a fastener for attaching the second plate to the bucket. A support structure is attached to the first and second plates, and is configured to support the handheld tool. A first clamp is attached to the support structure and is sized to receive a portion of the handheld tool, thereby at least partially securing the handheld tool to the support structure.

The invention also provides an adapter for attaching a handheld tool to a bucket of a prime mover that includes a unitary body having first and second ends and configured to support the handheld tool. The body further includes a first portion proximate the first end and configured for attachment to the bucket. The body also includes a second portion proximate the second end and configured to receive at least a portion of the handheld tool. A first clamp is adjustably attached to the body structure, and is configured to cooperate with the second portion of the body structure to capture a portion of the handheld tool therebetween. This at least partially secures the handheld tool.

The invention further provides an apparatus for attaching a handheld tool to a bucket of a prime mover. The apparatus includes an upper portion having a channel including first and second sides disposed opposite each other, and a third side connecting the first and second sides. An intermediate portion includes two elongate members attached to the upper portion and extending outwardly therefrom. A lower portion includes a third elongate member connecting the first and second elongate members, and a first clamp adjustably attached to the third elongate member for capturing a portion of the handheld tool therebetween.

### BRIEF DESCRIPTION OF THE DRAWINGS

FIG. 1 is a perspective view of one embodiment of an apparatus in accordance with the present invention;

FIG. 2 is a perspective view of a portion of a prime mover, including a bucket, having the apparatus shown in FIG. 1 attached thereto, and including a jack hammer attached to the apparatus;

FIG. 3 is a front view of the apparatus shown in FIG. 1;

FIG. 4 is a perspective view of another embodiment of an apparatus in accordance with the present invention; and

FIG. 5 is a perspective view of a portion of a prime mover, including a bucket, having the apparatus shown in FIG. 4 attached thereto, and including a pneumatic drill attached to the apparatus.

### DETAILED DESCRIPTION OF THE PREFERRED EMBODIMENT(S)

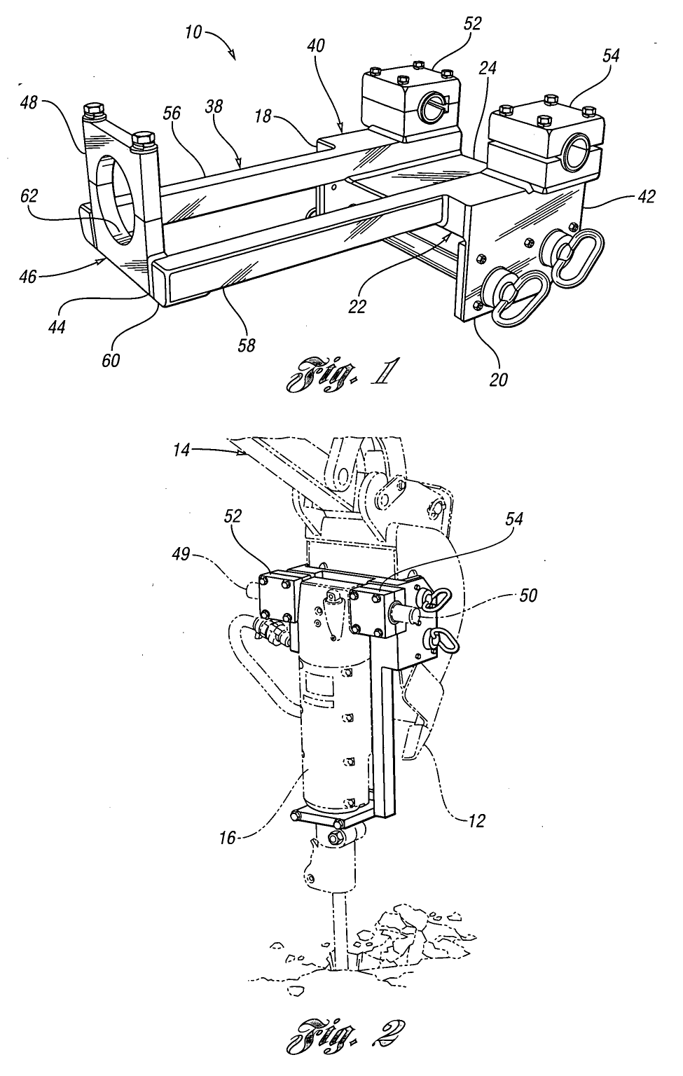

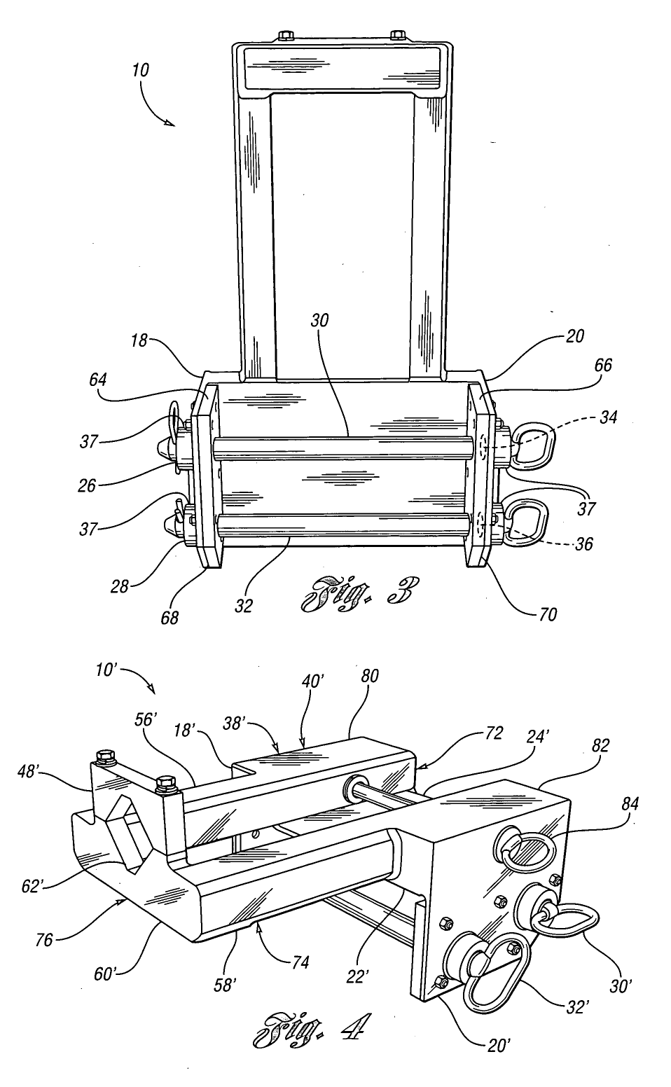

FIG. 1 shows an apparatus, or tool adapter 10, in accordance with the present invention. As explained more fully below, and shown in FIG. 2, the tool adapter 10 is configured for attachment to a bucket 12 of a prime mover, such as a backhoe 14. In addition, the tool adapter 10 is also configured to support a handheld tool, such as a jack hammer 16, so that the tool can be used in conjunction with the backhoe 14, rather than being operated in a handheld fashion. The tool adapter 10 includes first and second plates 18, 20 disposed opposite each other. The first and second plates 18, 20 form two sides of a channel 22 having a third side formed by a third plate 24.

As shown in FIG. 3, the first plate 18 has two apertures 26, 28 disposed therethrough for receiving a fastener, such as pins 30, 32, for attaching the first plate 18 to the bucket 12, shown in FIG. 3. Similarly, the second plate 20 includes apertures 34, 36 which are configured to respectively receive the pins 30, 32 for attaching the second plate 20 to the bucket 12. Although the pins 30, 32 are used for attaching the tool adapter 10 to the bucket 12, other types of fasteners, for example threaded fasteners, can be used. Providing additional strength in the area around the apertures 26, 28, 34, 36 are bosses 37 which may be conveniently welded onto the first and second plates 18, 20.

Returning to FIG. 1, it is shown that the tool adapter 10 includes a support structure 38 which is attached to the first and second plates 18, 20, and is configured to support a handheld tool, such as the jack hammer 16 shown in FIG. 2. In the embodiment shown in FIG. 1, the support structure 38 and the channel 22 form a unitary body 40 having first and second ends 42, 44. The channel 22 makes up a first portion of the body 40, while a second portion 46 of the body 40 is disposed proximate the second end 44. A first clamp 48 is adjustably attached to the body 40 and is configured to cooperate with the second portion 46 of the body 40 to capture a portion of the jack hammer 12 therebetween. It is worth noting that although the jack hammer 12 is used as an example of one tool that can be used with the present invention, it is contemplated that other tools—e.g., pneumatic drills, tampers, road saws, etc.—can also be used with the present invention.

As shown in FIG. 2, the jack hammer 12 includes handles 49, 50 which, although normally utilized by an operator in a handheld fashion, are conveniently secured to the tool adaptor 10 by a pair of second clamps 52, 54. As shown in FIG. 1, the support structure 38 includes first and second elongate members 56, 58 which are respectively attached to first and second plates 18, 20, and extend outwardly therefrom, generally parallel to each other. In the embodiment shown in FIG. 1, the elongate members 56, 58 are made from 1.5 inch square steel tube, which provides a combination of high strength and relatively low cost. Of course, the present invention contemplates the use of other materials and members having other cross-sectional geometries. The support structure 38 also includes a third elongate member 60 which is attached to the first and second elongate members 56, 58, and is generally perpendicular thereto. The third elongate member 60 includes a recess 62 therein, which helps to capture a tool, such as the jack hammer 12, when the first clamp 48 is tightened.

Returning to FIG. 3, it is shown that the tool adapter 10 also includes wear pads 64, 66 which are respectively attached to the first and second plates 18, 20. Specifically, the wear pads 64, 66 are configured for removable attachment to surfaces 68, 70 of the first and second plates 18, 20. One function of the wear pads 64, 66 is to form a barrier between the first and second plates 18, 20 and the bucket 12. In this way, the wear pads 64, 66 inhibit contact between the first and second plates 18, 20 and the bucket 12 when the tool adaptor 10 is attached to it. Although the wear pads 64, 66 can be made from any material effective to inhibit wear on the first and second plates 18, 20, a polymeric material having good wear properties, such as Delrin®, may be used. In addition to polymers, ceramics, metals, or some combination thereof, may be used for wear pad materials. The wear pads 64, 66 may be conveniently attached to the first and second plates 18, 20 with threaded fasteners or other attachment devices which will provide secure attachment while the tool adaptor 10 is in use, but at the same time, will allow the wear pads 64, 66 to be removed and replaced as needed.

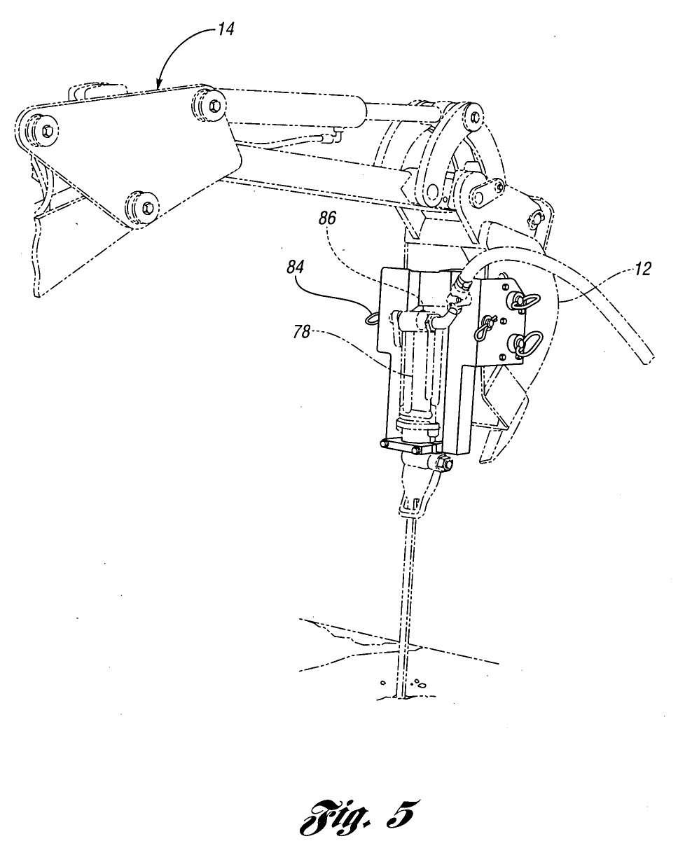

As noted above, a tool adapter, such as the tool adapter 10, can be easily configured to attach to different types of tools besides the jack hammer 16, shown in FIG. 3. For example, FIG. 4 shows a tool adapter 10′ in accordance with the present invention. Features of the tool adapter 10′ which are similar to, or the same as, features of the tool adapter 10, are designated with the prime symbol (′). The tool adapter 10′ includes an upper portion 72 which itself includes a channel 22′ defined by first, second and third sides 18′, 20′, 24′. In addition, the tool adapter 10′ includes an intermediate portion 74 which includes first and second elongate member 56′, 58′. The tool adapter 10′ also includes a lower portion 76 which includes a third elongate member 60′ having a recess, or concavity 62′ therein. A clamp 48′ is used to capture a portion of a tool, such as a pneumatic drill 78 shown in FIG. 5, to secure the drill 78 to the tool adapter 10′.

As described above, a tool adapter in accordance with the present invention can be configured to accommodate different types of handheld tools. Moreover, it can be configured to be attached to different buckets on different prime movers. For example, the tool adapter 10′, shown in FIG. 4, includes spacers 80, 82, which are sized to position the first and second plates 18′, 20′ appropriately to fit on the outside of the bucket 12. Appropriate sizing of the spacers 80, 82 not only ensures that the tool adapter 10′ will fit onto the bucket 12, but also allows the first and second elongate members 56′, 58′ to be positioned inboard towards the drill 78 (or other handheld tool being used). In the embodiment shown in FIG. 4, the spacers 80, 82 are respectively attached to the first and second plates 18′, 20′, and are also respectively attached to the first and second elongate members 56′, 58′, thereby adding to the overall structural integrity of the tool adapter 10′, which may undergo rigorous shock and vibration when a tool is being used.

The tool adapter 10, shown in FIG. 1, has an attachment structure that includes the second clamps 52, 54, which are configured to cooperate with the support structure 38 to secure the handles 49, 50 of the jack hammer 16 to the tool adapter 10. In contrast, the tool adapter 10′, shown in FIG. 4, includes a pin 84 which traverses a portion of a body 40′ of the tool adapter 10′. The pin 84 is configured to cooperate with the support structure 38′ to secure the drill 78 to the tool adapter 10′. The drill 78 includes an aperture 86 which is traversed by the pin 84 to help secure the drill 78 to the tool adapter 10. Thus, the combination of the clamp 48′ and the pin 84 provides a secure attachment for the drill 78, but at the same time, provides for fast changeover if a different tool is desired.

The tool adapter 10′, like the tool adapter 10, includes a welded metal construction, although it is understood that such tool adapters could be made from different materials, and at least partially assembled using one or more different types of fasteners. As with the tool adapter 10, the tool adapter 10′ includes pins 30′, 32′, which can be quickly secured to the bucket of a prime mover, such as the bucket 12 shown in FIGS. 2 and 5. The clamps 52, 54, shown in FIG. 1, and the pin 84, shown in FIG. 4, can be easily modified in terms of size or location to accommodate a wide variety of handheld tools. Moreover, the clamps 48, 48′ of the respective tool adapters 10, 10′ may in some case be able to provide the sole attachment for a handheld tool.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An apparatus for attaching a handheld tool to a bucket of a prime mover, the apparatus comprising:
a first plate including a first aperture therethrough for receiving a fastener for attaching the first plate to the bucket;
a second plate disposed opposite the first plate and including a second aperture therethrough for receiving a fastener for attaching the second plate to the bucket;
a support structure attached to the first and second plates and configured to support the handheld tool; and
a first clamp attached to the support structure and sized to receive a portion of the handheld tool, thereby at least partially securing the handheld tool to the support structure.

2. The apparatus of claim 1, further comprising an attachment structure configured to cooperate with the support structure and the handheld tool for at least partially securing the handheld tool to the support structure.

3. The apparatus of claim 2, wherein the attachment structure includes a pin disposed through a portion of the support structure, the pin being configured for insertion through at least one aperture in the handheld tool.

4. The apparatus of claim 2, wherein the attachment structure includes a pair of second clamps, each of the second clamps being sized to engage a portion of a handle of the handheld tool.

5. The apparatus of claim 1, wherein the first and second apertures are generally aligned with each other, and the fastener includes a pin configured for insertion through the first and second apertures and through a pair of corresponding apertures in the bucket, thereby securing the first and second plates to the bucket.

6. The apparatus of claim 1, further comprising first and second wear pads configured for respective attachment to the first and second plates, the first and second wear pads being configured for removable attachment to a respective surface of the first and second plates for inhibiting contact between the first and second plates and the bucket when the apparatus is attached to the bucket.

7. The apparatus of claim 6, wherein the wear pads include a polymeric material.

8. The apparatus of claim 1, wherein the support structure includes first and second elongate members respectively attached to the first and second plates and extending outwardly therefrom and generally parallel to each other, the support structure further including a third elongate member attached to the first and second elongate members and generally perpendicular thereto, the third elongate member having the first clamp attached thereto.

9. The apparatus of claim 8, wherein the third elongate member includes a recess therein for receiving a portion of the handheld tool.

10. An apparatus for attaching a handheld tool to a bucket of a prime mover, the apparatus comprising:
a unitary body including first and second ends and configured to support the handheld tool, the body further including a first portion proximate the first end and configured for attachment to the bucket, and a second portion proximate the second end and configured to receive at least a portion of the handheld tool; and
a first clamp adjustably attached to the body and configured to cooperate with the second portion of the body structure to capture a portion of the handheld tool therebetween, thereby at least partially securing the handheld tool.

11. The apparatus of claim 10, further comprising a pair of second clamps disposed proximate the first end, each of the second clamps being configured to capture a portion of a handle of the handheld tool, thereby at least partially securing the handheld tool.

12. The apparatus of claim 10, further comprising a pin configured to traverse at least a portion of the body and the handheld tool, thereby at least partially securing the handheld tool to the body.

13. The apparatus of claim 10, further comprising a pair of pins configured to traverse the first portion of the body and the bucket, thereby attaching the body to the bucket.

14. The apparatus of claim 10, further comprising at least one wear pad configured for removable attachment to the body for inhibiting contact between the body and the bucket when the body is attached to the bucket.

15. The apparatus of claim 10, wherein the second portion of the body includes a concavity therein disposed opposite the clamp for receiving a portion of the handheld tool.

16. An apparatus for attaching a handheld tool to a bucket of a prime mover, the apparatus comprising:
an upper portion including a channel having first and second sides disposed opposite each other and a third side connecting the first and second sides;
an intermediate portion including two elongate members attached to the upper portion and extending outwardly therefrom; and
a lower portion including a third elongate member connecting the first and second elongate members, and a first clamp adjustably attached to the third elongate member for capturing a portion of the handheld tool therebetween.

17. The apparatus of claim 16, further comprising first and second removable wear pads respectively attached to the first and second sides of the channel.

18. The apparatus of claim 16, further comprising a pair of second clamps respectively attached to the first and second elongate members, each of the second clamps being configured to engage a portion of a handle of the handheld tool, thereby at least partially securing the handheld tool.

19. The apparatus of claim 16, wherein each of the elongate members include a tubular member having a generally rectangular cross section.

20. The apparatus of claim 19, further comprising a pair of spacers attached to the channel, and each of the spacers also being attached to a respective elongate member, thereby further securing the elongate members to the upper portion.
